(19) United States
(12) Patent Application Publication
(10) Pub. No.: US 2018/0152301 A1
(43) Pub. Date: May 31, 2018

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Yoshimi UEZU, Kanagawa (JP); Takahiro MINAMIKAWA, Kanagawa (JP); Hiromoto ANDO, Kanagawa (JP)

(73) Assignee: FUJI XEROX CO., LTD., Tokyo (JP)

(21) Appl. No.: 15/491,367

(22) Filed: Apr. 19, 2017

(30) Foreign Application Priority Data
Nov. 30, 2016 (JP) 2016-232408

(51) Int. Cl. H04L 9/32; H04L 9/06

(52) U.S. Cl. CPC H04L 9/3263; H04L 9/0643

(57) ABSTRACT

An information processing apparatus includes: a receiving unit that receives an issue request for an electronic certificate from an external apparatus; an issuing unit that, when the issue request received by the receiving unit is for issuance of an electronic certificate using a first calculation method for calculating a hash value, issues the electronic certificate using the first calculation method; a transferring unit that, when the issue request received by the receiving unit is for issuance of an electronic certificate using a second calculation method different from the first calculation method, transfers the issue request to another information processing apparatus that issues an electronic certificate using the second calculation method; and a transmitting unit that, when receiving the electronic certificate using the second calculation method from the another information processing apparatus, transmits the received electronic certificate to the external apparatus that has transmitted the issue request.

### CROSS-REFERENCE TO RELATED APPLICATIONS

This application is based on and claims priority under 35 USC 119 from Japanese Patent Application No. 2016-232408 filed on Nov. 30, 2016.

### BACKGROUND

### Technical Field

The present invention relates to an information processing apparatus and a non-transitory computer readable medium.

An aspect of the invention provides an information processing apparatus including: a receiving unit that receives an issue request for an electronic certificate from an external apparatus; an issuing unit that, when the issue request received by the receiving unit is for issuance of an electronic certificate using a first calculation method for calculating a hash value, issues the electronic certificate using the first calculation method; a transferring unit that, when the issue request received by the receiving unit is for issuance of an electronic certificate using a second calculation method different from the first calculation method, transfers the issue request to another information processing apparatus that issues an electronic certificate using the second calculation method; and a transmitting unit that, when receiving the electronic certificate using the second calculation method from the another information processing apparatus, transmits the received electronic certificate to the external apparatus that has transmitted the issue request.

### BRIEF DESCRIPTION OF THE DRAWINGS

Exemplary embodiments of the present invention will be described in detail based on the following figures, wherein:

FIG. 1 is a system configuration diagram that does not support SHA2;

FIG. 2 is a diagram illustrating the manner in which an image forming apparatus obtains an electronic certificate issued by a certification authority server, and performs SSL communication with a service provider server;

FIG. 3 is a diagram illustrating the system configuration in the case where a hash value calculation algorithm is changed from SHA1 to SHA2 in the system configuration as illustrated in FIG. 1;

FIG. 4 is a diagram illustrating the hardware configuration of the certification authority server in a communication system according to an exemplary embodiment of the invention;

FIG. 5 is a block diagram illustrating the functional configuration of the certification authority server in a communication system according to an exemplary embodiment of the invention;

FIG. 6 is a flowchart for explaining the operation of electronic certificate issue processing performed by the certification authority server in a communication system according to an exemplary embodiment of the invention;

FIG. 7 is a sequence chart for explaining the manner in which the image forming apparatus transmits an issue request for an SHA1 electronic certificate to the certification authority server;

FIG. 8 is a sequence chart for explaining the manner in which the image forming apparatus transmits an issue request for an SHA2 electronic certificate to the certification authority server;

FIG. 9 is a block diagram illustrating the functional configuration of a certification authority server in another configuration in a communication system according to an exemplary embodiment of the invention; and

FIG. 10 is a diagram illustrating an example of a supported algorithm list table.

### DETAILED DESCRIPTION

### [Background]

First, in order to assist understanding of the invention, the background and summary of the invention will be described.

When data is transmitted and received via the Internet, encrypted communication called secure sockets layer (SSL) communication is used in order to improve the security of the data transmitted and received.

When SSL communication is performed, an electronic certificate (SSL server certificate) is used to protect the data against unauthorized access such as impersonation. The electronic certificate includes a public key of an apparatus and an electronic signature for the public key. The public key of the apparatus is used for encrypting SSL communication. The electronic signature is data encrypted by a secret key of a reliable third-party certification authority.

In general, an electronic signature system is widely used, in which a hash value of electronic data to be protected against falsification is calculated, and the hash value is encrypted with a secret key and added as the electronic signature.

Although various algorithms are present as algorithms (calculation methods) for calculating the hash value, at present, a hash value calculation algorithm that makes use of a hash function in the standard called Secure Hash Algorithm (SHA)-1 is commonly used.

In recent years, however, in order to further improve the security of SSL communication, the hash value calculation algorithm is widely scheduled to be changed from the SHA-1 standard to the SHA-2 standard.

For instance, in an algorithm called SHA-256 which is a system included in the SHA-2 standard, a hash length is 256 bits, and in contrast to the SHA-1 standard, the SHA-256 has a structure that increases the protection against malicious attacks and improves the security.

As a system which transmits and receives data using the above-described SSL communication, a specific system is proposed that implements the following services: automatic collection, by a service provider server, of information on the number of sheets used by, information on the life of consumables in, and information on malfunction of multifunctional apparatuses installed in an office or the like; preparation of an invoice; automatic delivery of consumables; and automatic notification of malfunction.

However, in an office where those multifunctional apparatuses are set, so-called firewall is often installed for the purpose of preventing information leakage, and the connection destinations such as uniform resource locators (URL) accessible by the multifunctional apparatuses may be limited.

Thus, in such a system configuration, when the hash value calculation algorithm (hash function) in an electronic signature system is attempted to be changed from the SHA-1 standard to the SHA-2 standard as described above, it is necessary to change the settings for the firewall so that a certification authority supporting the SHA-2 is accessible and an electronic certificate in the SHA-2 standard is obtainable by the multifunctional apparatuses.

However, even if an SSL communication program may be updated by a simple operation or remote control, in order to change the setting for the firewall or the like, time and effort is necessary to explain a situation to a system administrator or the like of an office where the image forming apparatus 10 is installed, and to ask the system administrator to change accessible connection destinations.

### Exemplary Embodiments of Invention

Next, an exemplary embodiment of the invention will be described in detail with reference to the drawings.

In the following, a case will be described in which SSL communication performed between an image forming apparatus and a service provider server is changed, where an algorithm using a hash function in the SHA-1 standard is replaced by an algorithm using a hash function in the SHA-2 standard.

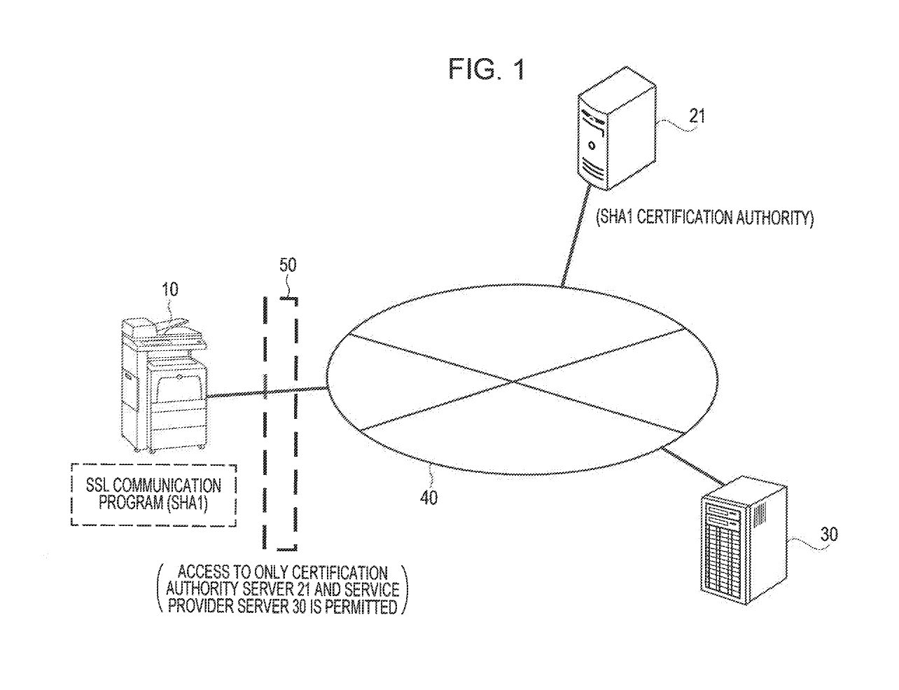

First, a system configuration is illustrated in FIG. 1, which only supports electronic certificates using the SHA-1 standard (hereinafter simply denoted by SHA1), and does not support electronic certificates using the SHA-2 standard (hereinafter simply denoted by SHA2).

The system illustrated in FIG. 1 has a configuration in which an image forming apparatus 10, a certification authority server 21 (information processing apparatus) having a function of issuing an electronic certificate using SHA1, and a service provider server 30 are connected via an Internet 40.

Here, a firewall 50 is provided between the image forming apparatus 10 and the Internet 40. Therefore, the image forming apparatus 10 is in a state where access to only the certification authority server 21 and the service provider server 30 is permitted.

It is to be noted that the image forming apparatus 10 is so-called a multifunctional apparatus that has multiple functions such as a print function, a scan function, a copy function, and a facsimile function.

The service provider server 30 has a function of obtaining information on the number of sheets printed per month and the status of consumables of the image forming apparatus 10 by transmitting and receiving data to and from the image forming apparatus 10 via the Internet 40.

In the image forming apparatus 10, an SSL communication program supporting an SHA1 electronic certificate is installed, so that the image forming apparatus 10 transmits various pieces of information to the service provision apparatus 30 via the SSL communication.

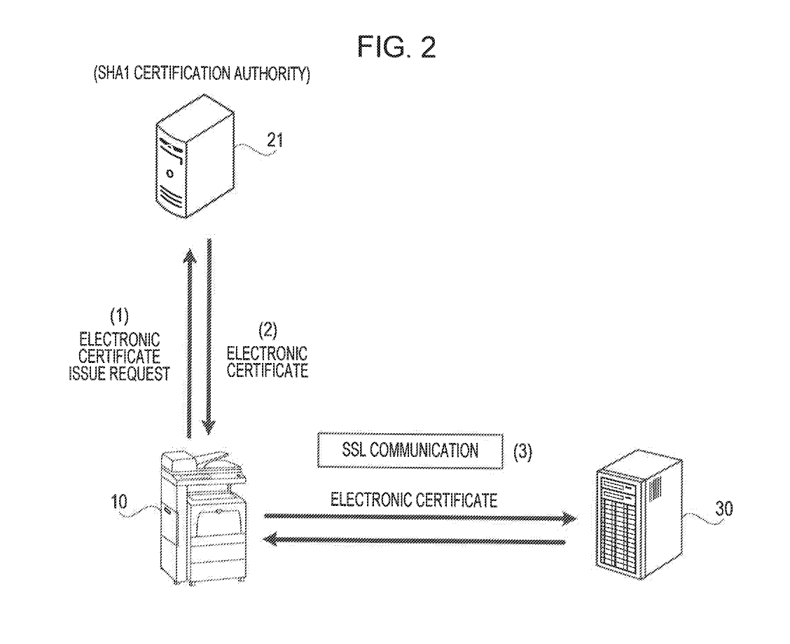

Specifically, as illustrated in FIG. 2, the image forming apparatus 10 (1) transmits an electronic certificate issue request to the certification authority server 21, (2) obtains an electronic certificate issued by the certification authority server 21, and (3) performs SSL communication with the service provider server 30 using the obtained electronic certificate.

In general, an effective period is set to such an electronic certificate, and when the effective period of an electronic certificate used has expired, an effective electronic certificate needs to be re-issued by requesting to a certification authority for re-issue of an electronic certificate.

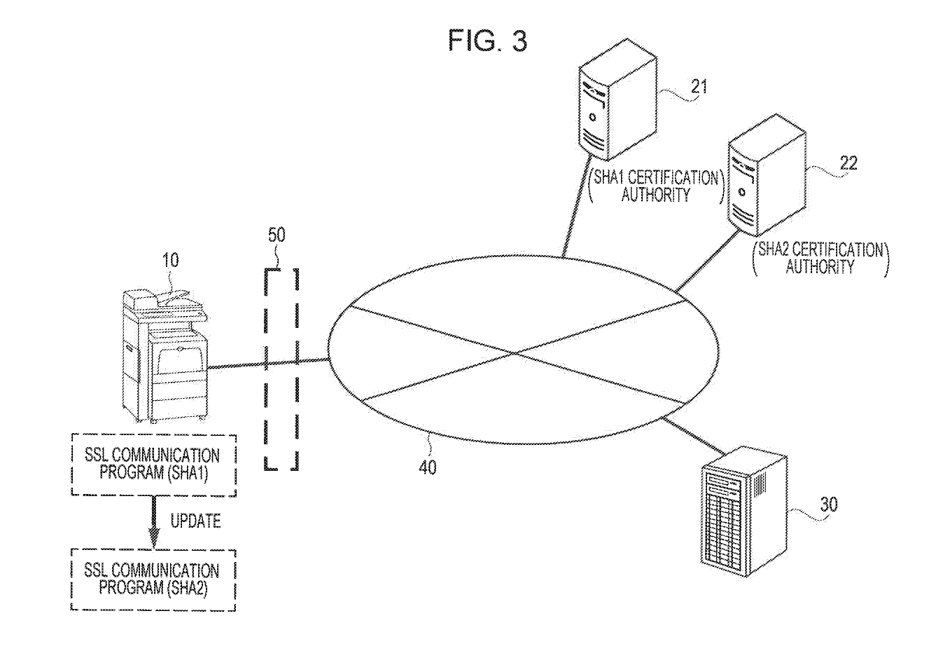

Next, FIG. 3 illustrates a system configuration in the case where the hash value calculation algorithm is changed from SHA1 to SHA2 in the system configuration as illustrated in FIG. 1.

First, in the image forming apparatus 10, the SSL communication program supporting an SHA1 electronic certificate is updated to an SSL communication program supporting an SHA2 electronic certificate. For instance, the update can be made by an operation in the image forming apparatus 10.

Since the previous SSL communication program has been thus updated to an SSL communication program supporting an SHA2 electronic certificate in the image forming apparatus 10, when an electronic certificate currently used is re-issued, an issue request for an SHA1 electronic certificate is transmitted to a certification authority.

In the system configuration illustrated in FIG. 3, a certification authority server 22 having a function of issuing an electronic certificate using SHA2 has been newly added.

However, the fire wall 50 is not set to allow the image forming apparatus 10 to have access to the certification authority server 22, and thus the image forming apparatus 10 cannot have direct access to the authentication authority server 22.

Thus, in a communication system according to an exemplary embodiment of the invention, the certification authority server 21 performs an operation different from a normal operation, thereby allowing the image forming apparatus 10 to obtain an electronic certificate using SHA2.

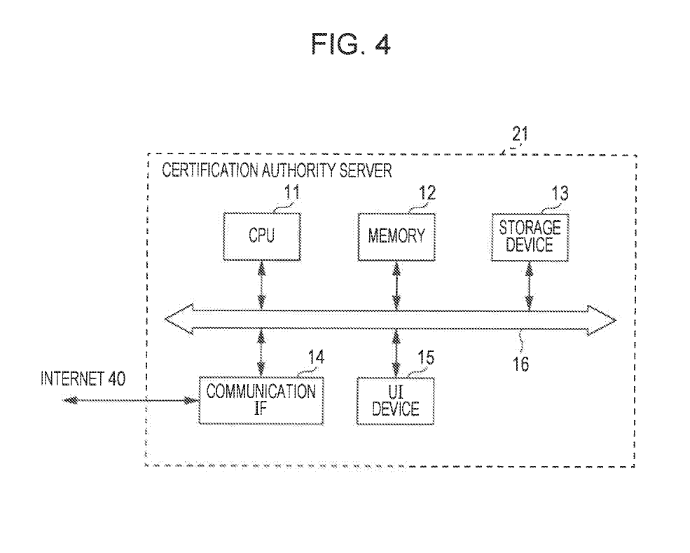

First, FIG. 4 illustrates the hardware configuration of the certification authority server 21 in the communication system of the exemplary embodiment.

As illustrated in FIG. 4, the certification authority server 21 has a CPU 11, a memory 12, a storage device 13 such as a hard disk drive (HDD), a communication interface (IF) 14 that transmits and receives data to and from an external apparatus via the Internet 40, and a user interface (UI) device 15 including a touch panel, a keyboard. These components are connected to each other via a control bus 16.

The CPU 11 executes predetermined processing in accordance with a control program stored in the memory 12 or the storage device 13, and controls the operation of the certification authority server 21. It is to be noted that although it has been described that the CPU 11 reads and executes the control program stored in the memory 12 or the storage device 13 in the exemplary embodiment, the program may be stored in a storage medium such as a CD-ROM and be provided to the CPU 11.

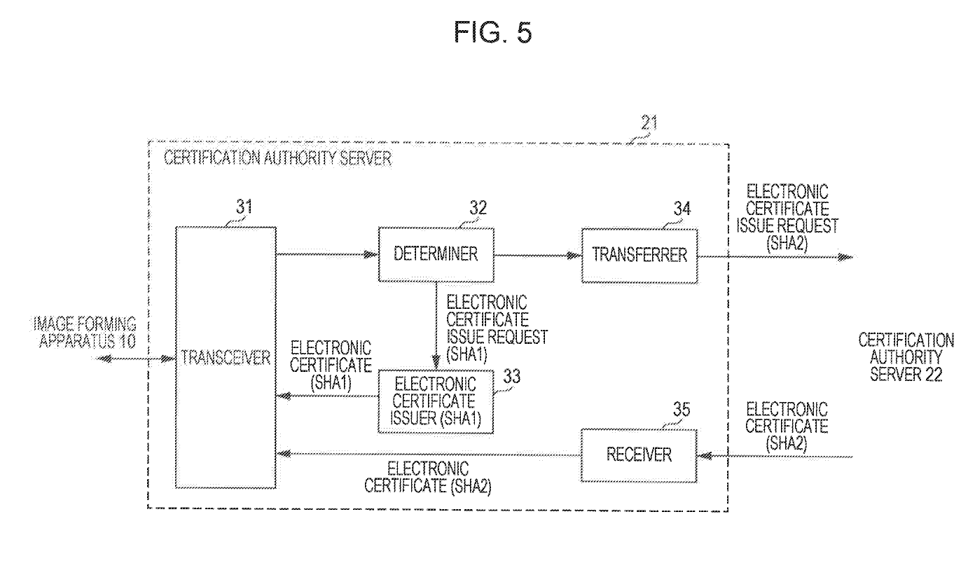

FIG. 5 is a block diagram illustrating the functional configuration of the certification authority server 21 which is implemented by executing the above-mentioned control program.

As illustrated in FIG. 5, the certification authority server 21 in this exemplary embodiment includes a transceiver 31, a determiner 32, an electronic certificate issuer 33, a transferrer 34, and a receiver 35.

The transceiver 31 receives an issue request for an electronic certificate via the Internet 40 from the image forming apparatus 10 which is an external apparatus. When the receiver 35 receives an SHA2 electronic certificate from the certification authority server 22 which is another information processing apparatus, the transceiver 31 transmits the received SHA2 electronic certificate to the image forming apparatus 10 which has transmitted an issue request for an electronic certificate.

The determiner 32 determines whether the electronic certificate issue request received by the transceiver 31 is an issue request for requesting issue of an SHA1 electronic certificate or an issue request for requesting issue of an SHA2 electronic certificate in which a hash value is calculated by an algorithm different from SHA1.

When it is determined by the determiner 32 that the issue request received by the transceiver 31 is an issue request for requesting issue of an SHA1 electronic certificate, the electronic certificate issuer 33 issues an SHA1 electronic certificate.

The SHA1 electronic certificate issued by the electronic certificate issuer 33 is transmitted to the image forming apparatus 10 by the transceiver 31.

When it is determined by the determiner 32 that the issue request received by the transceiver 31 is for requesting issue of an SHA2 electronic certificate which is more secure than an SHA1 electronic certificate, the transferrer 34 transfers the issue request for an SHA2 electronic certificate to the certification authority server 22.

The receiver 35 receives the SHA2 electronic certificate transmitted from the certification authority server 22.

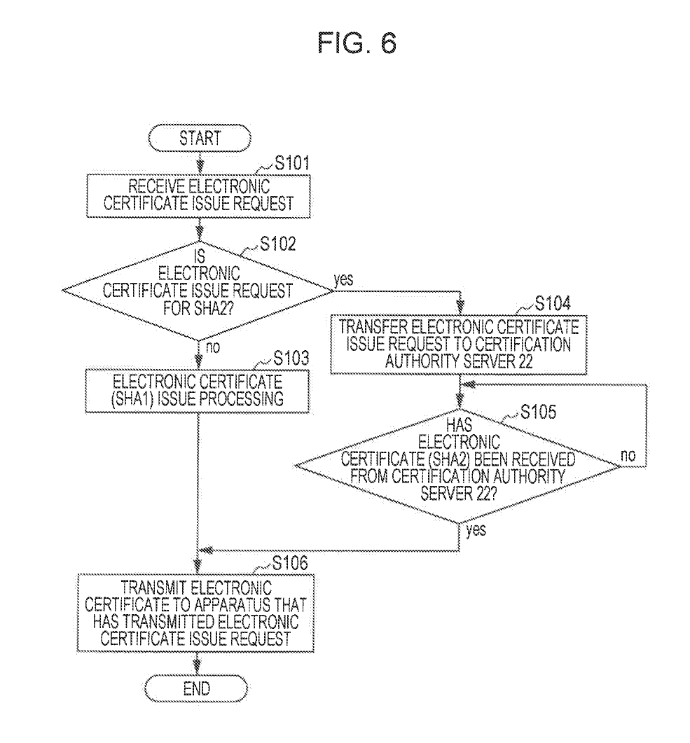

Next, the operation of electronic certificate issue processing performed by the certification authority server 21 in the communication system of this exemplary embodiment will be described with reference to the flowchart of FIG. 6.

First, when the transceiver 31 receives an issue request for an electronic certificate from the image forming apparatus 10 (step S101), the determiner 32 determines whether the received issue request for an electronic certificate is an issue request for an SHA1 electronic certificate or an issue request for an SHA2 electronic certificate (step S102).

When it is determined that the received issue request is an issue request for an SHA1 electronic certificate (no in step S102), the electronic certificate issuer 33 issues an SHA1 electronic certificate (step S103).

When it is determined that the received issue request is an issue request for an SHA2 electronic certificate (yes in step S102), the issue request for an SHA2 electronic certificate is transferred to the certification authority server 22 by the transferrer 34 (step S104).

SHA2 electronic certificate issue processing is then performed by the certification authority server 22 based on the received issue request for an electronic certificate.

The SHA2 electronic certificate issued by the certification authority server 22 is transmitted to the certification authority server 21, and the SHA2 electronic certificate is received by the receiver 35 in the certification authority server 21 (step S105).

Finally, either one of the SHA1 electronic certificate issued by the electronic certificate issuer 33 and the SHA2 electronic certificate received by the receiver 35 from the certification authority server 22 is transmitted by the transceiver 31 to the image forming apparatus 10 which has transmitted the issue request for an electronic certificate (step S106).

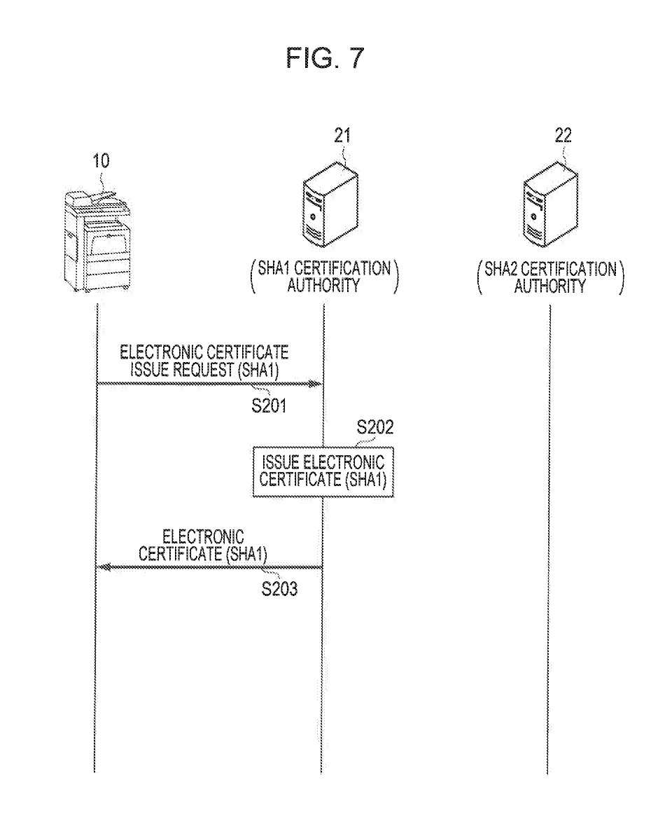

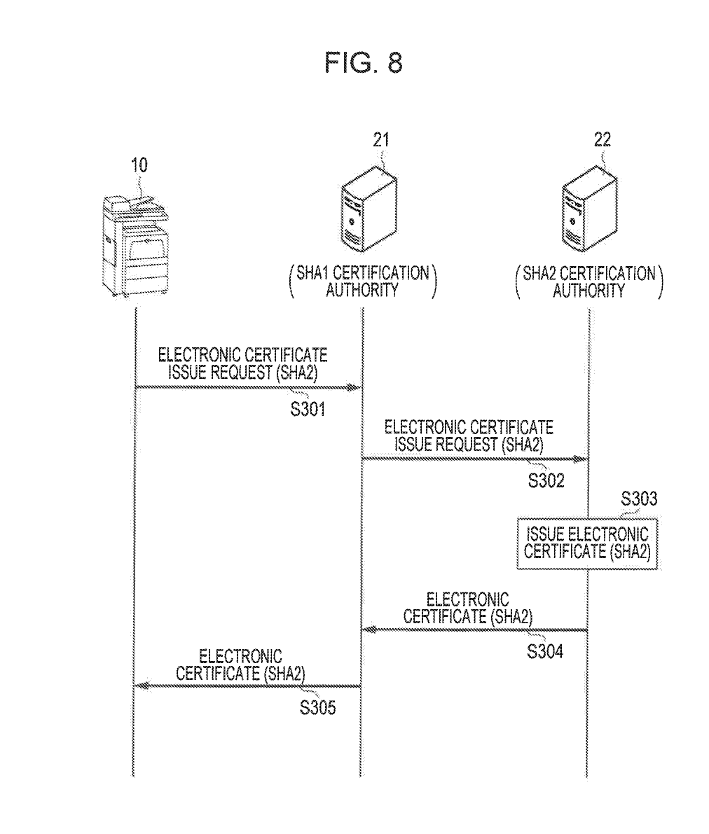

The manner how data is transmitted and received between the image forming apparatus 10 and the certification authority servers 21 and 22 by execution of the processing will be described with reference to the sequence charts of FIG. 7 and FIG. 8.

First, the case where the image forming apparatus 10 transmits an issue request for an SHA1 electronic certificate to the certification authority server 21 will be described with reference to the sequence chart of FIG. 7.

When the image forming apparatus 10 transmits an SHA1 electronic certificate issue request to the certification authority server 21 (step S201), the certification authority server 21 receives the issue request and issues an SHA1 electronic certificate (step S202).

The SHA1 electronic certificate is then transmitted from the certification authority server 21 to the image forming apparatus 10 (step S203).

Next, the case where the image forming apparatus 10 transmits an issue request for an SHA2 electronic certificate to the certification authority server 21 will be described with reference to the sequence chart of FIG. 8.

In the image forming apparatus 10, even when the SSL communication program supporting SHA1 is changed to an SSL communication program supporting SHA2, the transmission destination of an issue request for an electronic certificate is still the certification authority server 21.

Therefore, the image forming apparatus 10 transmits an issue request for an SHA2 electronic certificate to the certification authority server 21 (step S301).

Then, the certification authority server 21, which has received the issue request for an SHA2 electronic certificate, transfers the received issue request for an SHA2 electronic certificate to the certification authority server 22 because issue processing for the issue request cannot be performed by the certification authority server 21 (step S302).

The certification authority server 22, which has received the issue request for an SHA2 electronic certificate transferred from the certification authority server 21, performs the issue processing of an SHA2 electronic certificate based on the received issue request (step S303). The certification authority server 22 then transmits the issued SHA2 electronic certificate to the certification authority server 21 (step S304).

The certification authority server 21, which has received the transmitted SHA2 electronic certificate, transmits the received SHA2 electronic certificate to the image forming apparatus 10 (step S305).

The execution of the aforementioned processing allows the image forming apparatus 10 to receive an SHA2 electronic certificate from the certification authority server 21 by only transmitting an issue request for an SHA2 electronic certificate to the certification authority server 21.

It is to be noted that in the exemplary embodiment described above, the certification authority server 21 determines whether the issue request is for SHA1 or SHA2 based on the issue request for an electronic certificate received from the image forming apparatus 10.

However, information allowing to determine whether the image forming apparatus 10 supports an SHA1 electronic signature system or supports an SHA2 electronic signature system may be stored in the certification authority server 21, and whether an electronic certificate is to be issued by the certification authority server 21 or an issue request for an electronic certificate is to be transferred to the certification authority server 22 may be determined using the information.

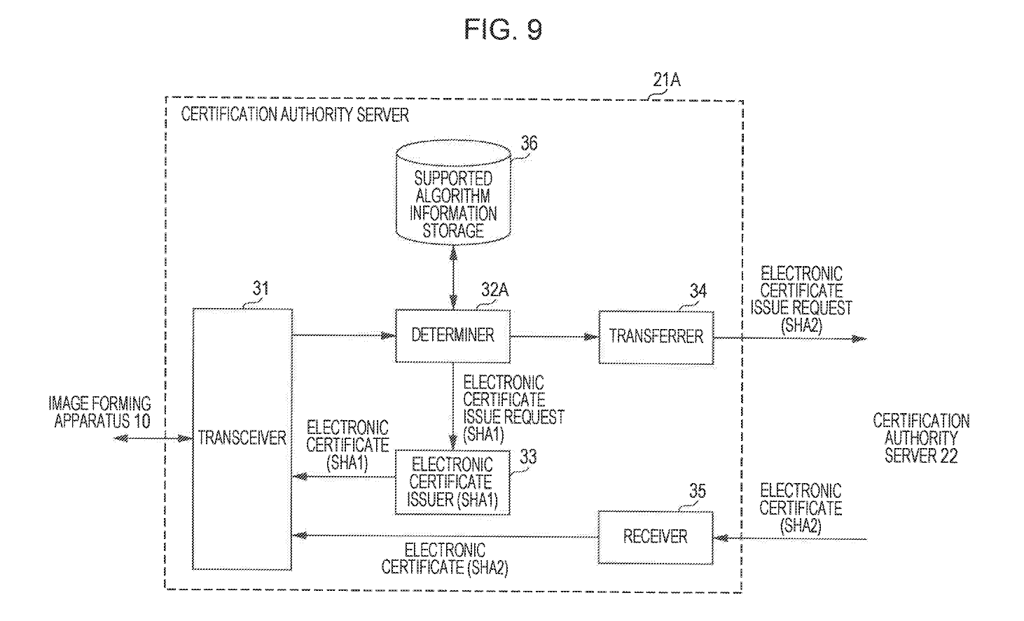

FIG. 9 is a block diagram illustrating the functional configuration of a certification authority server 21A in such a configuration.

The certification authority server 21A illustrated in FIG. 9 differs from the certification authority server 21 illustrated in FIG. 5 only in that a supported algorithm information storage 36 is added to the certification authority server 21 and the determiner 32 is replaced by a determiner 32A, and the both certification authority servers have the same configuration except for the aforementioned point.

The supported algorithm information storage 36 stores a supported algorithm list table that provides information which allows to determine whether the image forming apparatus 10 supports an SHA1 electronic signature system or supports an SHA2 electronic signature system.

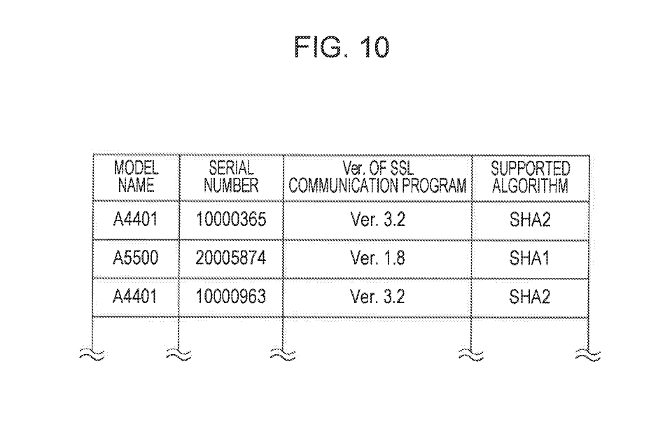

An example of the supported algorithm list table is illustrated in FIG. 10.

The supported algorithm list table illustrated in FIG. 10 stores information, for instance, on the firmware version of an installed SSL communication program, and a supported hash value calculation algorithm, for each model name and serial number of the image forming apparatus 10.

Thus, when an issue request for an electronic certificate is received from the image forming apparatus 10, and information on the model name and the serial number of the image forming apparatus 10 which has transmitted the issue request is known, the determiner 32A can determine whether the image forming apparatus 10 supports an SHA1 electronic certificate or supports an SHA2 electronic certificate.

When the determiner 32A determines that the image forming apparatus 10, from which an issue request is received by the transceiver 31, supports an SHA1 electronic certificate, the electronic certificate issuer 33 issues an SHA1 electronic certificate.

When the determiner 32A determines that the image forming apparatus 10, from which an issue request is received by the transceiver 31, supports an SHA2 electronic certificate, the transferrer 34 transfers the issue request for an SHA2 electronic certificate to the certification authority server 22.

Specifically, the transferrer 34 selectively transfers the issue request received by the transceiver 31 to the certification authority server 22 based on the information on the supported algorithm list table stored in the supported algorithm information storage 36.

### [Modification]

In the exemplary embodiment, description has been provided using the case where an electronic certificate used in the SSL communication is changed from a certificate in an electronic signature system using a hash function in the SHA1 standard to a certificate in an electronic signature system using a hash function in the SHA2 standard. However, the invention is not limited to this, and the invention is similarly applicable to a case where an electronic certificate is switched between electronic signature systems with different standards.

Also, in the exemplary embodiment, description has been provided using the case where SSL communication is performed between the image forming apparatus 10 and the service provider server 30. However, the invention is similarly applicable to a system in which SSL communication using an electronic certificate is performed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiving unit that receives an issue request for an electronic certificate from an external apparatus;
an issuing unit that, when the issue request received by the receiving unit is for issuance of an electronic certificate using a first calculation method for calculating a hash value, issues the electronic certificate using the first calculation method;
a transferring unit that, when the issue request received by the receiving unit is for issuance of an electronic certificate using a second calculation method different from the first calculation method, transfers the issue request to another information processing apparatus that issues an electronic certificate using the second calculation method; and
a transmitting unit that, when receiving the electronic certificate using the second calculation method from the another information processing apparatus, transmits the received electronic certificate to the external apparatus that has transmitted the issue request.

2. An information processing apparatus comprising:
a receiving unit that receives an issue request for an electronic certificate from an external apparatus;
an issuing unit that, when the external apparatus from which the issue request has been received by the receiving unit supports an electronic certificate using a first calculation method for calculating a hash value, issues the electronic certificate using the first calculation method;
a transferring unit that, when the external apparatus from which the issue request has been received by the receiving unit supports an electronic certificate using a second calculation method different from the first calculation method, transfers the issue request to another information processing apparatus that issues an electronic certificate using the second calculation method; and
a transmitting unit that, when receiving the electronic certificate using the second calculation method from the another information processing apparatus, transmits the received electronic certificate to the external apparatus that has transmitted the issue request.

3. The information processing apparatus according to claim 2, further comprising
a storage unit that stores information that allows to determine whether the external apparatus supports an electronic certificate using the first calculation method or supports an electronic certificate using the second calculation method,
wherein the transferring unit selectively transfers the issue request received by the receiving unit to the another information processing apparatus, based on the information stored in the storage unit.

4. The information processing apparatus according to claim 1,
wherein the first calculation method is a calculation method using a hash function in SHA-1 standard, and the second calculation method is a calculation method using a hash function in SHA-2 standard.

5. The information processing apparatus according to claim 2,
wherein the first calculation method is a calculation method using a hash function in the SHA-1 standard, and the second calculation method is a calculation method using a hash function in the SHA-2 standard.

6. The information processing apparatus according to claim 3,
wherein the first calculation method is a calculation method using a hash function in the SHA-1 standard, and the second calculation method is a calculation method using a hash function in the SHA-2 standard.

7. A non-transitory computer readable medium storing a program causing a computer to execute a process comprising:
receiving an issue request for an electronic certificate from an external apparatus;
when the issue request received by the receiving unit is for issuance of an electronic certificate using a first calculation method for calculating a hash value, issuing the electronic certificate using the first calculation method;
when the issue request received by the receiving unit is for issuance of an electronic certificate using a second calculation method different from the first calculation method, transferring the issue request to another information processing apparatus that issues an electronic certificate using the second calculation method; and
when receiving the electronic certificate using the second calculation method from the another information processing apparatus, transmitting the received electronic certificate to the external apparatus that has transmitted the issue request.
